(19) United States
(12) Patent Application Publication
(10) Pub. No.: US 2011/0144274 A1
(43) Pub. Date: Jun. 16, 2011

(54) PRODUCTION PROCESS OF OLEFIN POLYMERIZATION CATALYST AND OLEFIN POLYMER

(75) Inventors: Kazuo TAKAOKI, Ichihara-shi (JP); Kenji ATARASHI, Kimitsu-shi (JP); Kenichiro YADA, Sodegaura-shi (JP)

(73) Assignee: SUMITOMO CHEMICAL COMPANY, LIMITED, Tokyo (JP)

(21) Appl. No.: 12/947,896

(22) Filed: Nov. 17, 2010

(30) Foreign Application Priority Data
Dec. 15, 2009 (JP) 2009-283782

(51) Int. Cl. C08F 4/602; C08L 23/12

(52) U.S. Cl. 525/240; 502/104; 526/151

(57) ABSTRACT

A process for producing an olefin polymerization catalyst, comprising steps of (1) contacting a defined amount of a zinc compound represented by the defined formula, Zn(L¹)₂, with a defined amount of a halogenated alcohol represented by the defined formula, R¹R²R³C—OH, thereby forming a zinc atom-containing compound, and (2) contacting the zinc atom-containing compound, a solid catalyst component containing a titanium atom, a magnesium atom and a halogen atom, an organoaluminum compound, and an external electron donor with one another; and a production process of an olefin polymer, comprising a step of polymerizing an olefin in the presence of an olefin polymerization catalyst produced by the above process.

### FIELD OF THE INVENTION

The present invention relates to (i) a process for producing an olefin polymer, whose combination with a propylene polymer gives a resin composition excellent in its surface gloss, and in its balance between stiffness and impact resistance, and (ii) a process for producing an olefin polymerization catalyst used for a production process of such an olefin polymer.

### BACKGROUND OF THE INVENTION

Automobile materials and home appliance materials require lightness as well as high quality in their surface gloss, stiffness and impact resistance. Those materials can be seen in JP 2003-268191A (corresponding to US 2003/0176555A), for example, which discloses a polypropylene resin composition comprising (i) 100 parts by weight of a resin containing 75 to 95% by weight of a propylene-ethylene block copolymer, and 5 to 25% by weight of a copolymer rubber formed from ethylene and an α-olefin having 4 to 20 carbon atoms, and (ii) 0.3 to 2 parts by weight of talc.

### SUMMARY OF THE INVENTION

However, although the above polypropylene resin composition is excellent in its stiffness and impact resistance, its surface gloss is not satisfactory yet. Therefore, there has been desired a polypropylene resin composition excellent in its surface gloss, and in its balance between stiffness and impact resistance.

In view of the above circumstances, the present invention has an object to provide (i) a process for producing an olefin polymer, whose combination with a propylene polymer gives a resin composition excellent in its surface gloss, and in its balance between stiffness and impact resistance, and (ii) a process for producing an olefin polymerization catalyst used for a production process of such an olefin polymer.

The present invention is a process for producing an olefin polymerization catalyst, comprising steps of:

(1) contacting 1 part by mol of a zinc compound represented by following formula [1] with more than 0 part by mol to less than 2 parts by mol of a halogenated alcohol represented by following formula [2], thereby forming a zinc atom-containing compound; and

(2) contacting the zinc atom-containing compound, a solid catalyst component containing a titanium atom, a magnesium atom and a halogen atom, an organoaluminum compound, and an external electron donor with one another:

Zn(L¹)₂ [1]

wherein L¹ is a hydrocarbyl group having 1 to 20 carbon atoms, and two L¹s are the same as, or different from each other; and

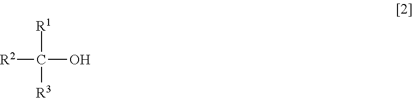

wherein R¹, R² and R³ are a hydrogen atom or a perhalocarbyl group having 1 to 20 carbon atoms, and are the same as, or different from one another; one or more of R¹, R² and R³ are the perhalocarbyl group; and any two of R¹, R² and R³ may be linked to each other to form a ring. This process is referred to hereinafter as “catalyst production process”.

Also, the present invention is a process for producing an olefin polymer, comprising a step of polymerizing an olefin in the presence of an olefin polymerization catalyst produced by the above process. This process is referred to hereinafter as “polymer production process”.

Further, the present invention is a polypropylene resin composition comprising 1 to 50% by weight of an olefin polymer produced by the above polymer production process, and 50 to 99% by weight of a propylene polymer, provided that the total of the olefin polymer and the propylene polymer is 100% by weight.

### DETAILED DESCRIPTION OF THE INVENTION

Examples of the hydrocarbyl group of L¹ in formula [1] are an alkyl group having 1 to 20 carbon atoms, an alkenyl group having 2 to 20 carbon atoms, an aryl group having 6 to 20 carbon atoms, and an aralkyl group having 7 to 20 carbon atoms.

L¹ may have a substituent such as a hydrocarbyloxy group. Examples of the hydrocarbyloxy group are an alkoxy group such as a methoxy group and an ethoxy group; an aryloxy group such as a phenoxy group; and an aralkyloxy group such as a benzyloxy group.

Examples of the above alkyl group of L¹ are a methyl group, an ethyl group, a n-propyl group, an isopropyl group, a n-butyl group, a sec-butyl group, a tert-butyl group, an isobutyl group, a n-pentyl group, a neopentyl group, a n-hexyl group, a n-heptyl group, a n-octyl group, a n-decyl group, a n-dodecyl group, a n-pentadecyl group and a n-eicosyl group. Among them, preferred is a methyl group, an ethyl group, an isopropyl group, a tert-butyl group or an isobutyl group.

Examples of the above alkenyl group of L¹ are a vinyl group, an allyl group, a propenyl group, a 2-methyl-2-propenyl group, a homoallyl group, a pentenyl group, a hexenyl group, a heptenyl group, an octenyl group, a nonenyl group, and a decenyl group.

Examples of the above aryl group of L¹ are a phenyl group, a 2-tolyl group, a 3-tolyl group, a 4-tolyl group, a 2,3-xylyl group, a 2,4-xylyl group, a 2,5-xylyl group, a 2,6-xylyl group, a 3,4-xylyl group, a 3,5-xylyl group, a 2,3,4-trimethylphenyl group, a 2,3,5-trimethylphenyl group, a 2,3,6-trimethylphenyl group, a 2,4,6-trimethylphenyl group, a 3,4,5-trimethylphenyl group, a 2,3,4,5-tetramethylphenyl group, a 2,3,4,6-tetramethylphenyl group, a 2,3,5,6-tetramethylphenyl group, a pentamethylphenyl group, an ethylphenyl group, a n-propylphenyl group, an isopropylphenyl group, a n-butylphenyl group, a sec-butylphenyl group, a tert-butylphenyl group, an isobutylphenyl group, a n-pentylphenyl group, a neopentylphenyl group, a n-hexylphenyl group, a n-octylphenyl group, a n-decylphenyl group, a n-dodecylphenyl group, a n-tetradecylphenyl group, a naphthyl group and an anthracenyl group. Among them, preferred is a phenyl group.

Examples of the above aralkyl group of L¹ are a benzyl group, a (2-methylphenyl)methyl group, a (3-methylphenyl)methyl group, a (4-methylphenyl)methyl group, a (2,3-dimethylphenyl)methyl group, a (2,4-dimethylphenyl)methyl group, (2,5-dimethylphenyl)methyl group, (2,6-dimethylphenyl)methyl group, (3,4-dimethylphenyl)methyl group, (3,5-dimethylphenyl)methyl group, (2,3,4-trimethylphenyl)methyl group, (2,3,5-trimethylphenyl)methyl group, (2,3,6-trimethylphenyl)methyl group, (3,4,5-trimethylphenyl)methyl group, (2,4,6-trimethylphenyl)methyl group, (2,3,4,5-tetramethylphenyl)methyl group, (2,3,4,6-tetramethylphenyl)methyl group, (2,3,5,6-tetramethylphenyl)methyl group, a (pentamethylphenyl)methyl group, an (ethylphenyl)methyl group, a (n-propylphenyl)methyl group, an (isopropylphenyl)methyl group, a (n-butylphenyl)methyl group, a (sec-butylphenyl)methyl group, a (tert-butylphenyl)methyl group, an (isobutylphenyl)methyl group, a (n-pentylphenyl)methyl group, a (neopentylphenyl)methyl group, a (n-hexylphenyl)methyl group, a (n-octylphenyl)methyl group, a (n-decylphenyl)methyl group, a naphthylmethyl group, and an anthracenylmethyl group. Among them, preferred is a benzyl group.

L¹ is preferably an alkyl group having 1 to 20 carbon atoms, or an aryl group having 6 to 20 carbon atoms, more preferably an alkyl group having 1 to 20 carbon atoms, further preferably a methyl group, an ethyl group, a n-propyl group, an isopropyl group, a n-butyl group, a sec-butyl group, a tert-butyl group, or an isobutyl group, and particularly preferably an ethyl group.

Examples of the zinc compound represented by formula [1] are a dialky zinc such as dimethyl zinc, diethyl zinc, di-n-propyl zinc, di-n-butyl zinc, diisobutyl zinc, and di-n-hexyl zinc; a diaryl zinc such as diphenyl zinc and dinaphthyl zinc; bis(cyclopentadienyl)zinc; and a dialkenyl zinc such as diallyl zinc. Among them, preferred is a dialky zinc, more preferred is dimethyl zinc, diethyl zinc, di-n-propyl zinc, di-n-butyl zinc, diisobutyl zinc, or di-n-hexyl zinc, further preferred is dimethyl zinc or diethyl zinc, and particularly preferred is diethyl zinc.

Examples of the perhalocarbyl group of R¹, R² and R³ in formula [2] are a perfluoromethyl group, a perfluoroethyl group, a perfluoro(n-propyl) group, a perfluoroisopropyl group, a perfluoro(n-butyl) group, a perfluoro(sec-butyl) group, a perfluoro(tert-butyl) group, a perfluoroisobutyl group, a perfluoro(n-pentyl) group, a perfluoroneopentyl group, a perfluoro(n-hexyl) group, a perfluoro(n-heptyl) group, a perfluoro(n-octyl) group, a perfluoro(n-decyl) group, a perfluoro(n-dodecyl) group, a perfluoro(n-pentadecyl) group, and a perfluoro(n-eicosyl) group; and perhalocarbyl groups obtained by changing “fluoro” in the above groups to “chloro”, “bromo” or “iodo”.

The perhalocarbyl group is preferably a perfluorocarbyl group. The perfluorocarbyl group is preferably a perfluorocarbyl group having 1 to 6 carbon atoms, more preferably a perfluoromethyl group, a perfluoroethyl group, a perfluoro(n-propyl) group, a perfluoroisopropyl group, a perfluoro(n-butyl) group, a perfluoro(sec-butyl) group, a perfluoro(tert-butyl) group, or a perfluoroisobutyl group, further preferably a perfluoromethyl group, a perfluoroethyl group, a perfluoroisopropyl group, or a perfluoro(tert-butyl) group, particularly preferably a perfluoromethyl group, a perfluoroethyl group, or a perfluoroisopropyl group, and most preferably a perfluoromethyl group or a perfluoroethyl group.

Examples of the halogenated alcohol represented by formula [2] are perfluoro(trimethyl)carbinol, which is also referred to as perfluoro-tert-butyl alcohol or 1,1-bis(trifluoromethyl)-2,2,2-trifluoroethanol, perfluoro(dimethylethyl)carbinol, perfluoro(diethylmethyl)carbinol, perfluoro(dimethylisopropyl)carbinol, perfluoro(triethyl)carbinol, perfluoro(ethylmethylisopropyl)carbinol, perfluoro(tert-butyldimethyl)carbinol, perfluoro(diethylisopropyl)carbinol, perfluoro(diisopropylmethyl)carbinol, perfluoro(tert-butylethylmethyl)carbinol, perfluoro(diisopropylethyl)carbinol, perfluoro(tert-butylisopropylmethyl)carbinol, perfluoro(tert-butyldiethyl)carbinol, perfluoro(triisopropyl)carbinol, perfluoro(tert-butylethylisopropyl)carbinol, perfluoro(di-tert-butylmethyl)carbinol, perfluoro(tert-butyldiisopropyl)carbinol, perfluoro(di-tert-butylethyl)carbinol, perfluoro(di-tert-butylisopropyl)carbinol, and perfluoro(tri-tert-butyl)carbinol. Among them, preferred is perfluoro(trimethyl)carbinol, perfluoro(dimethylethyl)carbinol, perfluoro(diethylmethyl)carbinol, perfluoro(dimethylisopropyl)carbinol, perfluoro(triethyl)carbinol, perfluoro(ethylmethylisopropyl)carbinol, perfluoro(diethylisopropyl)carbinol, perfluoro(diisopropylmethyl)carbinol, perfluoro(diisopropylethyl)carbinol, or perfluoro(triisopropyl)carbinol, and more preferred is perfluoro(trimethyl)carbinol, perfluoro(dimethylethyl)carbinol, perfluoro(diethylmethyl)carbinol, or perfluoro(triethyl)carbinol.

The contact of the zinc compound represented by formula [1] with the halogenated alcohol represented by formula [2] is carried out preferably in an atmosphere of inert gas, with or without a solvent. Contact temperature is usually −100 to 300° C., and preferably −80 to 200° C. Contact time is usually 1 minute to 200 hours, and preferably 10 minutes to 100 hours. As the above solvent, there are used a solvent inert to the zinc compound, the halogenated alcohol and a contact product thereof. Examples of the solvent are a non-polar solvent such as an aliphatic hydrocarbon solvent, an alicyclic hydrocarbon solvent, and an aromatic hydrocarbon solvent; and a polar solvent such as a halide solvent, an ether solvent, a carbonyl compound solvent, a phosphoric acid derivative solvent, a nitrile compound solvent, a nitro compound solvent, an amine solvent, and a sulfur compound solvent. Among them, preferred is an aliphatic hydrocarbon solvent, an alicyclic hydrocarbon solvent, an aromatic hydrocarbon solvent, or an ether solvent.

Examples of the above aliphatic hydrocarbon solvent are butane, pentane, hexane, heptane, octane, and 2,2,4-trimethylpentane. An example of the above alicyclic hydrocarbon solvent is cyclohexane. Examples of the above aromatic hydrocarbon solvent are benzene, toluene and xylene. Examples of the above halide solvent are dichloromethane, difluoromethane, chloroform, 1,2-dichloroethane, 1,2-dibromoethane, 1,1,2-trichloro-1,2,2-trifluoroethane, tetrachloroethylene, chlorobenzene, bromobenzene and o-dichlorobenzene. Examples of the above ether solvent are dimethyl ether, diethyl ether, diisopropyl ether, di-n-butyl ether, methyl-tert-butyl ether, anisole, 1,4-dioxane, 1,2-dimethoxyethane, bis(2-methoxyethyl)ether, tetrahydrofuran and tetrahydropyran. Examples of the above carbonyl compound solvent are acetone, ethyl methyl ketone, cyclohexanone, acetic anhydride, ethyl acetate, butyl acetate, ethylene carbonate, propylene carbonate, N,N-dimethylformamide, N,N-dimethylacetamide and N-methyl-2-pyrrolidone. Examples of the above phosphoric acid derivative solvent are hexamethylphosphate triamide and triethyl phosphate. Examples of the above nitrile compound solvent are acetonitrile, propionitrile, succinonitrile and benzonitrile. Examples of the above nitro compound solvent are nitromethane and nitrobenzene. Examples of the above amine solvent are pyridine, piperidine and morpholine. Examples of the above sulfur compound solvent are dimethylsulfoxide and sulfolane.

The halogenated alcohol represented by formula [2] is used in an amount of more than 0 to less than 2 mol, preferably 0.2 to 1.8 mol, more preferably 0.4 to 1.6 mol, further preferably 0.6 to 1.4 mol, particularly preferably 0.8 to 1.2 mol, and most preferably 0.9 to 1.1 mol, per 1 mol of the zinc compound represented by formula [1].

A zinc atom-containing compound formed by the contact of the zinc compound with the halogenated alcohol is preferably washed to remove starting compounds, although the zinc atom-containing compound may contain those starting compounds. A solvent for such washing is the same as, or different from the above solvent used for the contact. Such washing is carried out preferably in an atmosphere of inert gas, at usually −100 to 300° C., and preferably −80 to 200° C., and for usually 1 minute to 200 hours, and preferably 10 minutes to 100 hours.

After distilling away volatile matters from the formed zinc atom-containing compound, the zinc atom-containing compound is preferably dried under reduced pressure, preferably at 0° C. or higher for 1 to 24 hours, more preferably at 0 to 200° C. for 1 to 24 hours, further preferably at 10 to 200° C. for 1 to 24 hours, particularly preferably at 10 to 160° C. for 1 to 18 hours, and most preferably at 15 to 160° C. for 1 to 18 hours.

The following is an explanation of a process for producing a zinc atom-containing compound, by use of diethyl zinc as the zinc compound, and 1,1-bis(trifluoromethyl)-2,2,2-trifluoroethanol as the halogenated alcohol. The process comprises steps of (i) adding a hexane solution of diethyl zinc to toluene (solvent), (ii) cooling the resultant mixture down to 0° C., (iii) adding drop-wise the same molar amount of 1,1-bis(trifluoromethyl)-2,2,2-trifluoroethanol as that of diethyl zinc to the mixture, (iv) stirring the mixture at 0° C. for 10 minutes to 3 hours, (v) further stirring the mixture at 20 to 40° C. for 10 minutes to 24 hours, (vi) distilling away under reduced pressure volatile matters from the obtained reaction mixture, and (vii) drying the resultant material at room temperature under reduced pressure for 1 to 20 hours, thereby obtaining a zinc atom-containing compound.

The zinc atom-containing compound in the present invention is preferably a compound represented by following formula [3] and/or its associate:

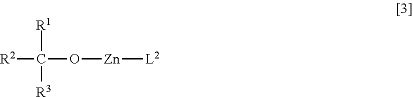

wherein R¹, R² and R³ are the same as those in formula [2], respectively; and L² is a hydrocarbyl group having 1 to 20 carbon atoms.

Examples of the hydrocarbyl group of L² are the same as those of L¹ mentioned above. Examples of the perhalocarbyl group of R¹, R² and R³ are the same as those of L¹ mentioned above.

Examples of the compound represented by formula [3] are methyl{perfluoro(trimethyl)carbyloxy}zinc, methyl{perfluoro(dimethylethyl)carbyloxy}zinc, methyl{perfluoro(diethylmethyl)carbyloxy}zinc, methyl{perfluoro(dimethylisopropyl)carbyloxy}zinc, methyl{perfluoro(triethyl)carbyloxy}zinc, methyl{perfluoro(ethylmethylisopropyl)carbyloxy}zinc, methyl{perfluoro(tert-butyldimethyl)carbyloxy}zinc, methyl{perfluoro(diethylisopropyl)carbyloxy}zinc, methyl{perfluoro(diisopropylmethyl)carbyloxy}zinc, methyl{perfluoro(tert-butylethylmethyl)carbyloxy}zinc, methyl{perfluoro(diisopropylethyl)carbyloxy}zinc, methyl{perfluoro(tert-butylisopropylmethyl)carbyloxy}zinc, methyl{perfluoro(tert-butyldiethyl)carbyloxy}zinc, methyl{perfluoro(triisopropyl)carbyloxy}zinc, methyl{perfluoro(tert-butylethylisopropyl)carbyloxy}zinc, methyl{perfluoro(di-tert-butylmethyl)carbyloxy}zinc, methyl{perfluoro(tert-butyldiisopropyl)carbyloxy}zinc, methyl{perfluoro(di-tert-butylethyl)carbyloxy}zinc, methyl{perfluoro(di-tert-butylisopropyl)carbyloxy}zinc, methyl{perfluoro(tri-tert-butyl)carbyloxy}zinc, ethyl{perfluoro(trimethyl)carbyloxy}zinc, ethyl{perfluoro(dimethylethyl)carbyloxy}zinc, ethyl{perfluoro(diethylmethyl)carbyloxy}zinc, ethyl{perfluoro(dimethylisopropyl)carbyloxy}zinc, ethyl{perfluoro(triethyl)carbyloxy}zinc, ethyl{perfluoro(ethylmethylisopropyl)carbyloxy}zinc, ethyl{perfluoro(tert-butyldimethyl)carbyloxy}zinc, ethyl{perfluoro(diethylisopropyl)carbyloxy}zinc, ethyl{perfluoro(diisopropylmethyl)carbyloxy}zinc, ethyl{perfluoro(tert-butylethylmethyl)carbyloxy}zinc, ethyl{perfluoro(diisopropylethyl)carbyloxy}zinc, ethyl{perfluoro(tert-butylisopropylmethyl)carbyloxy}zinc, ethyl{perfluoro(tert-butyldiethyl)carbyloxy}zinc, ethyl{perfluoro(triisopropyl)carbyloxy}zinc, ethyl{perfluoro(tert-butylethylisopropyl)carbyloxy}zinc, ethyl{perfluoro(di-tert-butylmethyl)carbyloxy}zinc, ethyl{perfluoro(tert-butyldiisopropyl)carbyloxy}zinc, ethyl{perfluoro(di-tert-butylethyl)carbyloxy}zinc, ethyl{perfluoro(di-tert-butylisopropyl)carbyloxy}zinc, ethyl{perfluoro(tri-tert-butyl)carbyloxy}zinc, n-propyl{perfluoro(trimethyl)carbyloxy}zinc, n-propyl{perfluoro(dimethylethyl)carbyloxy}zinc, n-propyl{perfluoro(diethylmethyl)carbyloxy}zinc, n-propyl{perfluoro(dimethylisopropyl)carbyloxy}zinc, n-propyl{perfluoro(triethyl)carbyloxy}zinc, n-propyl{perfluoro(ethylmethylisopropyl)carbyloxy}zinc, n-propyl{perfluoro(tert-butyldimethyl)carbyloxy}zinc, n-propyl{perfluoro(diethylisopropyl)carbyloxy}zinc, n-propyl{perfluoro(diisopropylmethyl)carbyloxy}zinc, n-propyl{perfluoro(tert-butylethylmethyl)carbyloxy}zinc, n-propyl{perfluoro(diisopropylethyl)carbyloxy}zinc, n-propyl{perfluoro(tert-butylisopropylmethyl)carbyloxy}zinc, n-propyl{perfluoro(tert-butyldiethyl)carbyloxy}zinc, n-propyl{perfluoro(triisopropyl)carbyloxy}zinc, n-propyl{perfluoro(tert-butylethylisopropyl)carbyloxy}zinc, n-propyl{perfluoro(di-tert-butylmethyl)carbyloxy}zinc, n-propyl{perfluoro(tert-butyldiisopropyl)carbyloxy}zinc, n-propyl{perfluoro(di-tert-butylethyl)carbyloxy}zinc, n-propyl{perfluoro(di-tert-butylisopropyl)carbyloxy}zinc, n-propyl{perfluoro(tri-tert-butyl)carbyloxy}zinc, n-butyl{perfluoro(trimethyl)carbyloxy}zinc, n-butyl{perfluoro(dimethylethyl)carbyloxy}zinc, n-butyl{perfluoro(diethylmethyl)carbyloxy}zinc, n-butyl{perfluoro(dimethylisopropyl)carbyloxy}zinc, n-butyl{perfluoro(triethyl)carbyloxy}zinc, n-butyl{perfluoro(ethylmethyldisopropyl)carbyloxy}zinc, n-butyl{perfluoro(tert-butyldimethyl)carbyloxy}zinc, n-butyl{perfluoro(diethylisopropyl)carbyloxy}zinc, n-butyl{perfluoro(diisopropylmethyl)carbyloxy}zinc, n-butyl{perfluoro(tert-butylethylmethyl)carbyloxy}zinc, n-butyl{perfluoro(diisopropylethyl)carbyloxy}zinc, n-butyl{perfluoro(tert-butylisopropylmethyl)carbyloxy}zinc, n-butyl{perfluoro(tert-butyldiethyl)carbyloxy}zinc, n-butyl{perfluoro(triisopropyl)carbyloxy}zinc, n-butyl{perfluoro(tert-butylethylisopropyl)carbyloxy}zinc, n-butyl{perfluoro(di-tert-butylmethyl)carbyloxy}zinc, n-butyl{perfluoro(tert-butyldiisopropyl)carbyloxy}zinc, n-butyl{perfluoro(di-tert-butylethyl)carbyloxy}zinc, n-butyl{perfluoro(di-tert-butylisopropyl)carbyloxy}zinc, n-butyl{perfluoro(tri-tert-butyl)carbyloxy}zinc, isobutyl{perfluoro(trimethyl)carbyloxy}zinc, isobutyl{perfluoro(dimethylethyl)carbyloxy}zinc, isobutyl{perfluoro(diethylmethyl)carbyloxy}zinc, isobutyl{perfluoro(dimethylisopropyl)carbyloxy}zinc, isobutyl{perfluoro(triethyl)carbyloxy}zinc, isobutyl{perfluoro(ethylmethylisopropyl)carbyloxy}zinc, isobutyl{perfluoro(tert-butyldimethyl)carbyloxy}zinc, isobutyl{perfluoro(diethylisopropyl)carbyloxy}zinc, isobutyl{perfluoro(diisopropylmethyl)carbyloxy}zinc, isobutyl{perfluoro(tert-butylethylmethyl)carbyloxy}zinc, isobutyl{perfluoro(diisopropylethyl)carbyloxy}zinc, isobutyl{perfluoro(tert-butylisopropylmethyl)carbyloxy}zinc, isobutyl{perfluoro(tert-butyldiethyl)carbyloxy}zinc, isobutyl{perfluoro(triisopropyl)carbyloxy}zinc, isobutyl{perfluoro(tert-butylethylisopropyl)carbyloxy}zinc, isobutyl{perfluoro(di-tert-butylmethyl)carbyloxy}zinc, isobutyl{perfluoro(tert-butyldiisopropyl)carbyloxy}zinc, isobutyl{perfluoro(di-tert-butylethyl)carbyloxy}zinc, isobutyl{perfluoro(di-tert-butylisopropyl)carbyloxy}zinc, isobutyl{perfluoro(tri-tert-butyl)carbyloxy}zinc, n-hexyl{perfluoro(trimethyl)carbyloxy}zinc, n-hexyl{perfluoro(dimethylethyl)carbyloxy}zinc, n-hexyl{perfluoro(diethylmethyl)carbyloxy}zinc, n-hexyl{perfluoro(dimethylisopropyl)carbyloxy}zinc, n-hexyl{perfluoro(triethyl)carbyloxy}zinc, n-hexyl{perfluoro(ethylmethylisopropyl)carbyloxy}zinc, n-hexyl{perfluoro(tert-butyldimethyl)carbyloxy}zinc, n-hexyl{perfluoro(diethylisopropyl)carbyloxy}zinc, n-hexyl{perfluoro(diisopropylmethyl)carbyloxy}zinc, n-hexyl{perfluoro(tert-butylethylmethyl)carbyloxy}zinc, n-hexyl{perfluoro(diisopropylethyl)carbyloxy}zinc, n-hexyl{perfluoro(tert-butylisopropylmethyl)carbyloxy}zinc, n-hexyl{perfluoro(tert-butyldiethyl)carbyloxy}zinc, n-hexyl{perfluoro(triisopropyl)carbyloxy}zinc, n-hexyl{perfluoro(tert-butylethylisopropyl)carbyloxy}zinc, n-hexyl{perfluoro(di-tert-butylmethyl)carbyloxy}zinc, n-hexyl{perfluoro(tert-butyldiisopropyl)carbyloxy}zinc, n-hexyl{perfluoro(di-tert-butylethyl)carbyloxy}zinc, n-hexyl{perfluoro(di-tert-butylisopropyl)carbyloxy}zinc, and n-hexyl{perfluoro(tri-tert-butyl)carbyloxy}zinc.

Among them, preferred is methyl{perfluoro(trimethyl)carbyloxy}zinc, methyl{perfluoro(dimethylethyl)carbyloxy}zinc, methyl{perfluoro(diethylmethyl)carbyloxy}zinc, methyl{perfluoro(dimethylisopropyl)carbyloxy}zinc, methyl{perfluoro(triethyl)carbyloxy}zinc, methyl{perfluoro(ethylmethylisopropyl)carbyloxy}zinc, methyl{perfluoro(tert-butyldimethyl)carbyloxy}zinc, methyl{perfluoro(diethylisopropyl)carbyloxy}zinc, methyl{perfluoro(diisopropylmethyl)carbyloxy}zinc, methyl{perfluoro(tert-butylethylmethyl)carbyloxy}zinc, methyl{perfluoro(diisopropylethyl)carbyloxy}zinc, methyl{perfluoro(tert-butylisopropylmethyl)carbyloxy}zinc, methyl{perfluoro(tert-butyldiethyl)carbyloxy}zinc, methyl{perfluoro(triisopropyl)carbyloxy}zinc, methyl{perfluoro(tert-butylethylisopropyl)carbyloxy}zinc, methyl{perfluoro(di-tert-butylmethyl)carbyloxy}zinc, methyl{perfluoro(tert-butyldiisopropyl)carbyloxy}zinc, methyl{perfluoro(di-tert-butylethyl)carbyloxy}zinc, methyl{perfluoro(di-tert-butylisopropyl)carbyloxy}zinc, methyl{perfluoro(tri-tert-butyl)carbyloxy}zinc, ethyl{perfluoro(trimethyl)carbyloxy}zinc, ethyl{perfluoro(dimethylethyl)carbyloxy}zinc, ethyl{perfluoro(diethylmethyl)carbyloxy}zinc, ethyl{perfluoro(dimethylisopropyl)carbyloxy}zinc, ethyl{perfluoro(triethyl)carbyloxy}zinc, ethyl{perfluoro(ethylmethylisopropyl)carbyloxy}zinc, ethyl{perfluoro(diethylisopropyl)carbyloxy}zinc, ethyl{perfluoro(diisopropylmethyl)carbyloxy}zinc, ethyl{perfluoro(diisopropylethyl)carbyloxy}zinc, or ethyl{perfluoro(triisopropyl)carbyloxy}zinc.

More preferred is ethyl{perfluoro(trimethyl)carbyloxy}zinc, ethyl{perfluoro(dimethylethyl)carbyloxy}zinc, ethyl{perfluoro(diethylmethyl)carbyloxy}zinc, ethyl{perfluoro(dimethylisopropyl)carbyloxy}zinc, ethyl{perfluoro(triethyl)carbyloxy}zinc, ethyl{perfluoro(ethylmethylisopropyl)carbyloxy}zinc, ethyl{perfluoro(diethylisopropyl)carbyloxy}zinc, ethyl{perfluoro(diisopropylmethyl)carbyloxy}zinc, ethyl{perfluoro(diisopropylethyl)carbyloxy}zinc, or ethyl{perfluoro(triisopropyl)carbyloxy}zinc; and further preferred is ethyl{perfluoro(trimethyl)carbyloxy}zinc, ethyl{perfluoro(dimethylethyl)carbyloxy}zinc, ethyl{perfluoro(diethylmethyl)carbyloxy}zinc, or ethyl{perfluoro(triethyl)carbyloxy}zinc.

The above associate of a zinc atom-containing compound represented by formula [3] means an aggregate of two or more structural units, provided that a structure represented by formula [3] means one structural unit. Examples of the associate are compounds represented by following formula [4] or [5].

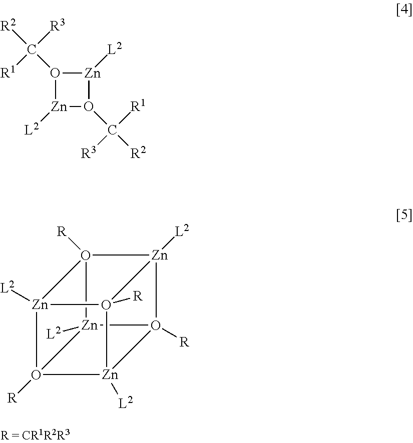

Examples of the solid catalyst component in the present invention are those disclosed in JP 57-63310A (corresponding to US 5,539,067), JP 58-83006A (corresponding to U.S. Pat. No. 49,552,649), JP 61-78803A, JP 7-216017A (corresponding to U.S. Pat. No. 5,608,018), JP 10-212319A (corresponding to U.S. Pat. No. 6,187,883), JP 62-158704A (corresponding to U.S. Pat. No. 4,816,433), JP 11-92518A or JP 2009-173870A (corresponding to US 2009/171045A).

Examples of a method for preparing the solid catalyst component are following methods (1) to (5):

(1) a method comprising a step of contacting a halogenated magnesium compound with a titanium compound;

(2) a method comprising a step of contacting (i) a halogenated magnesium compound, (ii) a titanium compound, and (iii) an internal electron donor with one another;

(3) a method comprising steps of (3-1) dissolving a halogenated magnesium compound and a titanium compound in an electron donor solvent, thereby obtaining a solution, and (3-2) impregnating a carrier with the solution;

(4) a method comprising a step of contacting (i) a dialkoxymagnesium compound, (ii) a halogenated titanium compound, and (iii) an internal electron donor with one another; and

(5) a method comprising a step of contacting (i) a solid component containing a magnesium atom, a titanium atom, and a hydrocarbyloxy group, (ii) a halogenated compound, and (iii) an internal electron donor and/or organic acid halide with one another.

Among them, preferred is the solid catalyst component prepared by method (5), wherein the solid catalyst component preferably contains a phthalic ester as the internal electron donor.

Examples of the organoaluminum compound in the present invention are a trialkylaluminum such as trimethylaluminum, triethylaluminum, triisobutylaluminum, trihexylaluminum, trioctylaluminum and tridecylaluminum; an alkylaluminum halide such as diethylaluminum monochloride, diisobutylaluminum monochloride, ethylaluminum sesquichloride, and ethylaluminum dichloride; an alkylaluminum hydride such as diethylaluminum hydride and diisobutylaluminum hydride; aluminum alkoxide such as diethylaluminum ethoxide and diethylaluminum phenoxide; an alumoxane such as methylalumoxane, ethylalumoxane, isobutylalumoxane, and methylisobutylalumoxane; and a combination of two or more thereof. Among them, preferred is a trialkylaluminum, and more preferred is triethylaluminum.

The external electron donor in the present invention is preferably a silicon compound represented by following formula [7]:

R⁷ᵣSi(OR⁸)₄₋ᵣ [7]

wherein R⁷ is a hydrogen atom, a hydrocarbyl group having 1 to 20 carbon atoms, or a hetero atom-containing group, and when plural R⁷s exist, they are the same as, or different from one another; R⁸ is a hydrocarbyl group having 1 to 20 carbon atoms, and when plural R⁸s exist, they are the same as, or different from one another; and r is an integer of 0 to 3.

Examples of the hydrocarbyl group of R⁷ and R⁸ are a linear alkyl group having 1 to 20 carbon atoms such as a methyl group, an ethyl group, a propyl group, a butyl group, and a pentyl group; a branched alkyl group having 3 to 20 carbon atoms such as an isopropyl group, a sec-butyl group, a tert-butyl group, and a tert-amyl group; a cycloalkyl group having 3 to 20 carbon atoms such as a cyclopentyl group and a cyclohexyl group; a cycloalkenyl group having 3 to 20 carbon atoms such as a cyclopentenyl group; and an aryl group having 6 to 20 carbon atoms such as a phenyl group and a tolyl group.

Examples of the hetero atom-containing group of R⁷ are an oxygen atom-containing group such as a furyl group, a pyranyl group and a perhydrofuryl group; a nitrogen atom-containing group such as a dimethylamino group, a methylethylamino group, a diethylamino group, an ethyl-n-propylamino group, a di-n-propylamino group, a pyrrolyl group, a pyridyl group, a pyrrolidinyl group, a piperidyl group, a perhydroindolyl group, a perhydroisoindolyl group, a perhydroquinolyl group, a perhydroisoquinolyl group, a perhydrocarbazolyl group, and a perhydroacridinyl group; a sulfur atom-containing group such as a thienyl group; and a phosphorus atom-containing group. Among them, preferred is a hetero atom-containing group whose hetero atom is directly linked to the silicon atom in formula [7], and more preferred is a dimethylamino group, a methylethylamino group, a diethylamino group, an ethyl-n-propylamino group, or a di-n-propylamino group.

Examples of the external electron donor are diisopropyldimethoxysilane, diisobutyldimethoxysilane, di-tert-butyldimethoxysilane, tert-butylmethyldimethoxysilane, tert-butylethyldimethoxysilane, tert-butyl-n-propyldimethoxysilane, tert-butyl-n-butyldimethoxysilane, tert-amylmethyldimethoxysilane, tert-amylethyldimethoxysilane, tert-amyl-n-propyldimethoxysilane, tert-amyl-n-butyldimethoxysilane, isobutylisopropyldimethoxysilane, tert-butylisopropyldimethoxysilane, dicyclobutyldimethoxysilane, cyclobutylisopropyldimethoxysilane, cyclobutylisobutyldimethoxysilane, cyclobutyl-tert-butyldimethoxysilane, dicyclopentyldimethoxysilane, cyclopentylisopropyldimethoxysilane, cyclopentylisobutyldimethoxysilane, cyclopentyl-tert-butyldimethoxysilane, dicyclohexyldimethoxysilane, cyclohexylmethyldimethoxysilane, cyclohexylethyldimethoxysilane, cyclohexylisopropyldimethoxysilane, cyclohexylisobutyldimethoxysilane, cyclohexyl-tert-butyldimethoxysilane, cyclohexylcyclopentyldimethoxysilane, cyclohexylphenyldimethoxysilane, diphenyldimethoxysilane, phenylmethyldimethoxysilane, phenylisopropyldimethoxysilane, phenylisobutyldimethoxysilane, phenyl-tert-butyldimethoxysilane, phenylcyclopentyldimethoxysilane, diisopropyldiethoxysilane, diisobutyldiethoxysilane, di-tert-butyldiethoxysilane, tert-butylmethyldiethoxysilane, tert-butylethyldiethoxysilane, tert-butyl-n-propyldiethoxysilane, tert-butyl-n-butyldiethoxysilane, tert-amylmethyldiethoxysilane, tert-amylethyldiethoxysilane, tert-amyl-n-propyldiethoxysilane, tert-amyl-n-butyldiethoxysilane, dicyclopentyldiethoxysilane, dicyclohexyldiethoxysilane, cyclohexylmethyldiethoxysilane, cyclohexylethyldiethoxysilane, diphenyldiethoxysilane, phenylmethyldiethoxysilane, 2-norbornanemethyldimethoxysilane, bis(perhydroquinoline)dimethoxysilane, bis(perhydroisoquinoline)dimethoxysilane, (perhydroquinolino)(perhydroisoquinolino)dimethoxysilane, (perhydroquinolino)methyldimethoxysilane, (perhydroisoquinolino)methyldimethoxysilane, (perhydroquinolino)ethyldimethoxysilane, (perhydroisoquinolino)ethyldimethoxysilane, (perhydroquinolino)(n-propyl)dimethoxysilane, (perhydroisoquinolino)(n-propyl)dimethoxysilane, (perhydroquinolino)(tert-butyl)dimethoxysilane, (perhydroisoquinolino)(tert-butyl)dimethoxysilane, diethylaminotriethoxysilane, and a combination of two or more thereof.

Examples of an olefin in the polymer production process of the present invention are a linear olefin such as ethylene, propylene, 1-butene, 1-pentene, 1-hexene, 1-heptene, 1-octene and 1-decene; a branched olefin such as 3-methyl-1-butene, 3-methyl-1-pentene and 4-methyl-1-pentene; an alicyclic olefin such as vinylcyclohexane; and a combination of two or more thereof.

An olefin polymer in the present invention is preferably a homopolymer of propylene, or a copolymer of propylene with other olefin such as a propylene-ethylene copolymer, a propylene-1-butene copolymer, and a propylene-1-hexene copolymer. The copolymer contains a polymerization unit of the other olefin in an amount of usually 0.01 to 40% by weight, and preferably 0.1 to 30% by weight, provided that the total of the propylene unit and the other olefin unit contained in the copolymer is 100% by weight. The copolymer has an intrinsic viscosity of usually 0.5 to 15 dl/g, and preferably 0.8 to 10 dl/g.

The polymer production process of the present invention has one or more polymerization steps. Those plural polymerization steps are the same as, or different from one another, in their monomer type, monomer amount or polymerization condition. An olefin polymer produced from the final polymerization step is substantially a mixture of respective polymers produced in those polymerization steps.

The polymer production process of the present invention comprises preferably steps of:

(I) polymerizing propylene in the presence of the olefin polymerization catalyst in the present invention, thereby forming a propylene homopolymer (hereinafter referred to as “polymer part (1)”); and

(II) copolymerizing propylene with ethylene in the presence of polymer part (1) to forming a propylene-ethylene random copolymer (hereinafter referred to as “polymer part (2”), thereby obtaining a mixture of polymer parts (1) and (2), which corresponds to the olefin polymer in the present invention.

In order to control polymerization activity in step (II), or in order to improve adhesiveness or quality of a powdery olefin polymer formed in step (II), a polymerization activity-control agent may be added to step (II) or between steps (I) and (II). Examples of the polymerization activity-control agent are an alcohol such as methanol, ethanol, isopropanol and butanol; and oxygen-containing gas such as oxygen, carbon monoxide and carbon dioxide.

Above polymer part (1) may be a propylene-ethylene copolymer containing 5% by weight or less of an ethylene unit, provided that the total of the propylene-ethylene copolymer is 100% by weight. Polymer part (1) has an intrinsic viscosity of preferably 0.5 to 4 dl/g, and more preferably 0.6 to 3 dl/g. Above polymer part (2) contains an ethylene unit in an amount of preferably 10 to 60% by weight, provided that the total of polymer part (2) is 100% by weight. Polymer part (2) has an intrinsic viscosity of preferably 1.5 dl/g or more, and more preferably 2 to 15 dl/g. The above mixture obtained in step (II) contains preferably 25 to 98% by weight of polymer part (1), and 2 to 75% by weight of polymer part (2), provided that the total of polymer parts (1) and (2) is 100% by weight.

The above zinc atom-containing compound, solid catalyst component, organoaluminum compound, and external electron donor are contacted with one another, with or without the use of a solvent dissolving them, and inside or outside a polymerization reactor. While they are not particularly limited in their contact order, they are contacted preferably by a method comprising steps of (i) feeding the organoaluminum compound and the external electron donor to a polymerization reactor, and then (ii) feeding a contact product of the zinc atom-containing compound and the solid catalyst component to the polymerization reactor, wherein such feeding is carried out preferably in an atmosphere of inert gas such as nitrogen and argon, and in a state free from moisture.

The organoaluminum compound is used in an amount of usually 1 to 1,000 mol, and preferably 5 to 600 mol, per one mol of a titanium atom contained in the solid catalyst component used, in the polymer production process. The external electron donor is used in an amount of usually 0.1 to 2,000 mol, preferably 0.3 to 1,000 mol, and more preferably 0.5 to 800 mol, per one mol of a titanium atom contained in the solid catalyst component used, and is used in an amount of usually 0.001 to 5 mol, preferably 0.005 to 3 mol, and more preferably 0.01 to 1 mol, per one mol of the organoaluminum compound used, in the polymer production process.

The polymer production process is carried out at usually −30 to 300° C., preferably 20 to 180° C., and more preferably 40 to 100° C., under pressure of usually atmospheric pressure to 10 MPa, and preferably 200 kPa to 5 MPa.

The polymer production process is carried out by (i) a slurry polymerization method with the use of an inert hydrocarbon solvent such as propane, butane, isobutane, pentane, hexane, heptane, and octane, (ii) a solution polymerization method with the use of such an inert hydrocarbon solvent, (iii) a bulk polymerization method with the use of a medium of an olefin, which is liquid at polymerization temperature, (iv) a gas-phase polymerization method, or (v) a combined method of two or more thereof, and is carried out by a continuous method, a batch-wise method, or a combined method thereof. The polymer production process may be carried out by use of plural polymerization reactors, which are connected with one another in series, and are different from one another in their polymerization conditions. Polymerization conditions of one polymerization reactor may be changed continuously inside the polymerization reactor. The polymer production process may use a chain transfer agent such as hydrogen, in order to control molecular weight of an olefin polymer obtained.

The solid catalyst component used in step (2) of the catalyst production process may be replaced with a pre-polymerized solid catalyst component mentioned below. Therefore, the “solid catalyst component” in step (2) of the catalyst production process also means the “pre-polymerized solid catalyst component”.

The pre-polymerized solid catalyst component can be usually obtained preferably by slurry-polymerizing a small amount of an olefin in the presence of the above-mentioned solid catalyst component and orgaoaluminum compound, wherein the pre-polymerized olefin is the same as, or different from an olefin polymerized in the polymer production process. The slurry polymerization uses an inert hydrocarbon solvent such as propane, butane, isobutane, pentane, isopentane, hexane, heptane, octane, cyclohexane, benzene and toluene, which may be replaced partially or totally with a liquid olefin.

The organoaluminum compound in the pre-polymerization is used in an amount of usually 0.5 to 700 mol, preferably 0.8 to 500 mol, and more preferably 1 to 200 mol, per one mol of a titanium atom contained in the solid catalyst component used in the pre-polymerization.

The olefin is pre-polymerized in an amount of usually 0.01 to 1,000 g, preferably 0.05 to 500 g, and more preferably 0.1 to 200 g, per one gram of the solid catalyst component used.

The pre-polymerization is carried out in a slurry concentration of preferably 1 to 500 g-solid catalyst component/liter-solvent, and more preferably 3 to 300 g-solid catalyst component/liter-solvent; at preferably −20 to 100° C., and more preferably 0 to 80° C.; for usually 30 seconds to 15 hours; under olefin partial pressure in a gas phase of preferably 1 kPa to 2 MPa, and more preferably 10 kPa to 1 MPa, which is not applied to an olefin having a liquid state under the above pre-polymerization pressure, or at the above pre-polymerization temperature.

Examples of a method for feeding a solid catalyst component, an organoaluminum compound and an olefin to a pre-polymerization reactor are (1) a method comprising steps of contacting the solid catalyst component and the organoaluminum compound with each other, thereby forming a contact product, and feeding the contact product and the olefin to the pre-polymerization reactor, and (2) a method comprising steps of contacting the solid catalyst component and the olefin with each other, thereby forming a contact product, and feeding the contact product and the organoaluminum compound to the pre-polymerization reactor. Examples of a method for feeding an olefin to a pre-polymerization reactor are (1) a method comprising a step of feeding thereto an olefin sequentially so as to keep an inner pressure of a pre-polymerization reactor at predetermined pressure, and (2) a method comprising a step of feeding thereto the total of a predetermined amount of an olefin at the beginning. The pre-polymerization may use a chain transfer agent such as hydrogen, in order to control molecular weight of an olefin polymer pre-polymerized.

The pre-polymerization may use the above zinc atom-containing compound or external electron donor in addition to the solid catalyst component and orgaoaluminum compound. The external electron donor is used in an amount of usually 0.01 to 400 mol, preferably 0.02 to 200 mol, and more preferably 0.03 to 100 mol, per one mol of a titanium atom contained in the solid catalyst component used in the pre-polymerization, and is used in an amount of usually 0.003 to 5 mol, preferably 0.005 to 3 mol, and more preferably 0.01 to 2 mol, per one mol of the organoaluminum compound used in the pre-polymerization.

Examples of a method for feeding an external electron donor to a pre-polymerization reactor are (1) a method comprising a step of feeding thereto the external electron donor separately from the organoaluminum compound, and (2) a method comprising a step of feeding thereto a contact product of the external electron donor with the organoaluminum compound.

The polypropylene resin composition of the present invention comprises 1 to 50% by weight, and preferably 2 to 10% by weight of an olefin polymer produced by the polymer production process of the present invention, and 50 to 99% by weight, and preferably 90 to 98% by weight of a propylene polymer, provided that the total of the olefin polymer and the propylene polymer is 100% by weight. The “propylene polymer” in the present invention means a polymer containing a polymerization unit of propylene as a major polymerized monomer unit.

The above propylene polymer can be produced preferably by a process comprising steps of:

(1′) polymerizing propylene or copolymerizing propylene with ethylene in the presence of a polymerization catalyst formed by contacting the above solid catalyst component, organoaluminum compound and external electron donor with one another, thereby forming a part of a propylene homopolymer, or a part of a propylene-ethylene copolymer containing 5% by weight or less of an ethylene unit, provided that the total of the propylene-ethylene copolymer is 100% by weight; and

(2′) copolymerizing propylene with ethylene in the presence of the above-formed two polymer parts, thereby forming a propylene-ethylene random polymer.

The polypropylene resin composition of the present invention can be produced, for example, by a method comprising a step of melt kneading an olefin polymer with a propylene polymer by use of a melt kneader. Examples of the melt kneader are PLASTOMILL, a Banbury mixer, BRABENDER PLASTOGRAPH, a uniaxial extruder, and a twin screw extruder. Among them, preferred is a uniaxial extruder or a twin screw extruder. The melt kneading is carried out usually at 170 to 250° C. (polymer temperature) for 1 to 20 minutes. Examples of a method for feeding the olefin polymer and propylene polymer to a melt kneader are (i) a method comprising a step of feeding the total amount of them at a time, and (ii) a method comprising a step of feeding them successively.

The polypropylene resin composition of the present invention may contain an additive. Examples of the additive are an inorganic filler, an ethylene-α-olefin copolymer rubber, a rubber containing a polymerization unit of a vinyl aromatic compound, an antioxidant, an ultraviolet absorber, a lubricant, a pigment, an antistatic agent, a copper inhibitor, a fire retardant, a neutralizing agent, a blowing agent, a plasticizer, a nucleating agent, a bubble inhibitor, and a cross-linking agent. It is preferable for the polypropylene resin composition to contain an antioxidant or an ultraviolet absorber, in order to improve its heat resistance, weather resistance and oxidation resistance. An example of the neutralizing agent is calcium stearate. Examples of the antioxidant are a phenolic antioxidant such as IRGANOX 1010 manufactured by Ciba Specialty Chemicals K.K., and a phosphorus atom-containing antioxidant such as IRGAFOS 168 manufactured by Ciba Specialty Chemicals K.K. The inorganic filler contributes to stiffness of an article molded from the polypropylene resin composition. Examples of the inorganic filler are calcium carbonate, talc and magnesium sulfate fiber. Among them, preferred is talc, magnesium sulfate fiber, or a combination thereof.

The inorganic filler is used with or without modification, and an example of the modification is a surface treatment thereof with a surface-activate agent such as a silane coupling agent, a titanium coupling agent, a higher fatty acid, an ester of a higher fatty acid, an amide of a higher fatty acid, and a salt of a higher fatty acid, in order to improve compatibility between the inorganic filler and the polypropylene resin composition, or in order to improve dispersibility of the inorganic filler in the polypropylene resin composition.

The rubber containing a polymerization unit of a vinyl aromatic compound contributes to further improvement of a balance of mechanical properties of an article molded from the polypropylene resin composition. An example of the rubber containing a polymerization unit of a vinyl aromatic compound is a block copolymer containing a polymer block of a vinyl aromatic compound and a polymer block of a conjugated diene. The polymer block of a conjugated diene contains a hydrogenated carbon-to-carbon double bond in a ratio of preferably 80% by weight or more, and more preferably 85% by weight or more, provided that the total of an original carbon-to-carbon double bond is 100% by weight. Examples of the rubber containing a polymerization unit of a vinyl aromatic compound are a block copolymer such as styrene-ethylene-butene-styrene rubber (SEBS), styrene-ethylene-propylene-styrene rubber (SEPS), styrene-butadiene rubber (SBR), styrene-butadiene-styrene rubber (SBS), and styrene-isoprene-styrene rubber (SIS); and hydrogenated rubbers thereof. A further example of the rubber containing a polymerization unit of a vinyl aromatic compound is a rubber obtained by a reaction of a vinyl aromatic compound (for example, styrene) with ethylene-propylene-non-conjugated diene rubber (EPDM). Above rubbers may be used in a combination of two or more thereof.

The polypropylene resin composition of the present invention can be molded by a molding method such as an injection molding method, an injection compression molding method, a gas assist molding method, and an extrusion molding method, thereby making a part for a product such as an electrical product and an automobile. Among them, particularly preferred is an automobile part such as a door trim, a piller, an instrumental panel, and bumper.

### EXAMPLE

The present invention is explained in more detail with reference to the following Examples, which do not limit the present invention.

### Example 1

### 1. Preparation of Zinc Atom-Containing Compound

To a glass vessel purged with nitrogen gas was charged 0.4 mL (containing 0.80 mmol of diethyl zinc) of a hexane solution (concentration: 2.0 mol/L) of diethyl zinc (zinc compound). Then, 0.5 mL (containing 0.80 mmol of perfluoro-tert-butyl alcohol) of a heptane solution (concentration: 1.6 mol/L) of perfluoro-tert-butyl alcohol (halogenated alcohol) was added thereto drop-wise at room temperature. The resultant mixture was stirred for 3 minutes, thereby obtaining a solution of a zinc atom-containing compound, the solution containing 0.80 mmol of a zinc atom.

### 2. Preparation of Solid Catalyst Component

### (1) Preparation of Solid Material

A reactor equipped with a stirrer was purged with nitrogen gas, and then 800 liters of hexane, 6.8 kg of diisobutyl phthalate, 350 kg of tetraethoxysilane, and 38.8 kg of tetrabutoxytitanium were charged to the reactor. The resultant mixture was stirred, and 900 liters of a dibutyl ether solution (concentration: 2.1 mol/liter) of butylmagnesium chloride were added drop-wise thereto at 7° C. over 5 hours under stirring. After completion of the drop-wise addition, the mixture was stirred at 20° C. for one hour. The reaction mixture was filtered to separate a solid. The separated solid was washed three times with each 1,100 liters of toluene to obtain a washed solid. Toluene was added to the washed solid, thereby obtaining 625 liters of toluene slurry of the solid. The toluene slurry was heated at 70° C. for one hour under stirring, and then was cooled down to room temperature, thereby obtaining a solid material-containing toluene slurry.

A part of the toluene slurry was dried under reduced pressure, thereby obtaining a dried solid material. The dried solid material was found to contain 2. 1% by weight of a titanium atom, 38.9% by weight of an ethoxy group, and 3.4% by weight of a butoxy group, provided that the total of the dried solid material was 100% by weight. All the above titanium atoms were found to be trivalent.

### (2) Treatment of Solid Material

### (2-1) First Treatment

A 100 mL flask equipped with a stirrer, a dropping funnel and a thermometer was purged with nitrogen gas. To the flask was charged the above solid material-containing toluene slurry in an amount corresponding to 8 g of the dried solid material. The supernatant liquid in the flask was taken out till the total volume of the slurry was decreased to 26.5 mL. To the slurry, was added a mixture of 16.0 mL of titanium tetrachloride with 0.8 mL of dibutyl ether at 40° C., and further was added drop-wise a mixture of 2.0 mL of phthalic acid dichloride with 2.0 mL of toluene over five minutes. After completion of the drop-wise addition, the resultant reaction mixture was stirred at 115° C. for four hours, and was filtered at 115° C. to separate a solid component.

### (2-2) Second Treatment

The above-separated solid component was washed three times at 115° C. with each 40 mL of toluene. Toluene was added to the washed solid component, thereby obtaining 26.5 mL of toluene slurry. To the toluene slurry was added a mixture of 0.8 mL of dibutyl ether, 0.45 mL of diisobutyl phthalate, and 6.4 mL of titanium tetrachloride. The mixture was stirred at 105° C. for one hour, and was filtered at 105° C. to separate a solid component.

### (2-3) Third Treatment

The above-separated solid component was washed two times at 105° C. with each 40 mL of toluene. Toluene was added to the washed solid component, thereby obtaining 26.5 mL of toluene slurry. The toluene slurry was heated up to 105° C., and a mixture of 0.8 mL of dibutyl ether and 6.4 mL of titanium tetrachloride was added to the toluene slurry. The mixture was stirred at 105° C. for one hour, and was filtered at 105° C. to separate a solid component.

### (2-4) Fourth Treatment

The above-separated solid component was washed two times at 105° C. with each 40 mL of toluene. Toluene was added to the washed solid component, thereby obtaining 26.5 mL of toluene slurry. The toluene slurry was heated up to 105° C., and a mixture of 0.8 mL of dibutyl ether and 6.4 mL of titanium tetrachloride was added to the toluene slurry. The mixture was stirred at 105° C. for one hour, and was filtered at 105° C. to separate a solid component.

### (2-5) Fifth Treatment

The above-separated solid component was washed six times at 105° C. with each 40 mL of toluene, and then was further washed three times at room temperature with each 40 mL of hexane. The washed solid component was dried under reduced pressure, thereby obtaining a solid catalyst component.

The solid catalyst component was found to contain 1.6% by weight of a titanium atom, 0.06% by weight of an ethoxy group, 0.15% by weight of a butoxy group, 7.6% by weight of diethyl phthalate, 0.8% by weight of ethyl-n-butyl phthalate, and 2.5% by weight of diisobutyl phthalate, provided that the total of the solid catalyst component was 100% by weight.

### 3. Preparation of Olefin Polymer

A 3 liter stainless steel autoclave equipped with a stirrer was dried in a vacuum, and then was purged with argon gas. To the autoclave were charged (i) 780 g of propylene, (ii) a mixture of 4.4 mmol of triethylaluminum (organoaluminum compound) and 0.52 mmol of cyclohexylethyldiethoxysilane (external electron donor) and (iii) a mixture of the total amount of the above-prepared zinc atom-containing compound, and 18.1 mg of the above-prepared solid catalyst component, in this order, thereby polymerizing propylene at 70° C. for 60 minutes to form a propylene homopolymer.

After the unreacted propylene was purged, and 0.8 g of the resultant polypropylene was taken out for a measurement of its viscosity, a mixed gas of ethylene (flow rate: 3.0 NL/minute) and propylene (flow rate: 5.5 NL/minute) was fed continuously to the autoclave so as to keep its inner pressure at 0.6 MPa, thereby copolymerizing propylene and ethylene at 55° C. for 120 minutes to form a propylene-ethylene random copolymer.

The resultant polymer product was dried at 60° C. for 5 hours under reduced pressure, thereby obtaining 226 g of a copolymer of propylene and ethylene (herein referred to as “olefin polymer (1)”), corresponding to a mixture of the former propylene homopolymer and the latter propylene-ethylene random copolymer.

Olefin polymer (1) was found to have an intrinsic viscosity, [η]T, of 2.53 dl/g; the propylene homopolymer in olefin polymer (1) was found to have an intrinsic viscosity, [η]P, of 3.02 dl/g; and the propylene-ethylene random copolymer in olefin polymer (1) was found to have an intrinsic viscosity, [η]EP, of 2.24 dl/g. Olefin polymer (1) was found to contain 63.1% by weight of the propylene-ethylene random copolymer, provided that the total of olefin polymer (1) was 100% by weight. The propylene-ethylene random copolymer was found to contain 41.1% by weight of a polymerization unit of ethylene, provided that the total of the propylene-ethylene random copolymer was 100% by weight. Results are shown in Table 1.

The above intrinsic viscosity, [η]T and [η]P, was measured by a method comprising steps of:

(1) measuring respective reduced viscosities of TETRALINE solutions having respective concentrations of 0.1 g/dl, 0.2 g/dl and 0.5 g/dl, at 135° C. with an Ubbellohde viscometer; and

(2) calculating an intrinsic viscosity by a method described in “Kobunshi yoeki, Kobunshi jikkengaku 11” (published by Kyoritsu Shuppan Co. Ltd. in 1982), page 491, namely, by plotting those reduced viscosities for those concentrations, and then extrapolating the concentration to zero.

The above intrinsic viscosity, NEP, was calculated from the following formula:

[η]EP=[η]T/X−{(1/X)−1}[η]P

wherein X is a ratio by weight of the propylene-ethylene random copolymer in olefin polymer (1) to olefin polymer (1).

The above amount (63.1% by weight) of the propylene-ethylene random copolymer contained in olefin polymer (1), and the above amount (41.1% by weight) of a polymerization unit of ethylene contained in the propylene-ethylene random copolymer were measured using a ¹³C-NMR equipment, AVANCE 600, manufactured by Bruker Corporation, under the following conditions:
measurement mode: proton-decoupling method,
pulse width: 8 p second,
pulse recurrence period: 4 seconds,
cumulated number: 20,000,
solvent: mixed solvent of 75 parts by weight of 1,2-dichlorobenzene and 25 parts by weight of 1,2-dichlorobenzene-d4,
internal standard material: tetramethylsilane, and
sample concentration: 200 mg/3.0 mL-solvent,
   wherein a peak assignment of a ¹³C-NMR spectrum was in accordance with a method disclosed in M. Kakugo, et al., Macromolecules, Vol. 15, 1150 (1982).

### Example 2

Example 1 was repeated except that (i) 18.1 mg of the solid catalyst component was changed to 16.8 mg thereof, (ii) 1.2 MPa of hydrogen was added to the propylene polymerization, (iii) the propylene gas-flow rate of 5.5 NL/minute was changed to 5.0 NL/minute, and (iv) the copolymerization time of 120 minutes was changed to 150 minutes, thereby obtaining 295 g of a copolymer of propylene and ethylene (herein referred to as “olefin polymer (2)”).

Olefin polymer (2) was found to have [η]T of 1.17 dl/g; the propylene homopolymer in olefin polymer (2) was found to have [η]P of 0.79 dl/g; and the propylene-ethylene random copolymer in olefin polymer (2) was found to have [η]EP of 2.18 dl/g. Olefin polymer (2) was found to contain 27.3% by weight of the propylene-ethylene random copolymer. The propylene-ethylene random copolymer was found to contain 42.0% by weight of a polymerization unit of ethylene. Results are shown in Table 1.

### Comparative Example 1

Example 1 was repeated except that (i) the zinc atom-containing compound was not used, (ii) 18.1 mg of the solid catalyst component was changed to 16.8 mg thereof, (iii) the propylene polymerization time of 60 minutes was changed to 20 minutes, (iv) 1.8 MPa of hydrogen was added to the propylene polymerization, (v) the ethylene gas-flow rate of 3.0 NL/minute was changed to 6.0 NL/minute, (vi) the propylene gas-flow rate of 5.5 NL/minute was changed to 5.0 NL/minute, (vii) hydrogen gas having a flow rate of 0.1 NL/minute was used, (viii) the copolymerization temperature of 55° C. was changed to 60° C., and (iX) the copolymerization time of 120 minutes was changed to 30 minutes, thereby obtaining 396 g of a copolymer of propylene and ethylene (herein referred to as “olefin polymer (3)”).

Olefin polymer (3) was found to have [η]T of 1.24 dl/g; the propylene homopolymer in olefin polymer (3) was found to have [η]P of 0.93 dl/g; and the propylene-ethylene random copolymer in olefin polymer (3) was found to have [η]EP of 2.71 dl/g. Olefin polymer (3) was found to contain 17.4% by weight of the propylene-ethylene random copolymer. The propylene-ethylene random copolymer was found to contain 51.6% by weight of a polymerization unit of ethylene. Results are shown in Table 1.

### Comparative Example 2

Example 1 was repeated except that (i) the zinc atom-containing compound was not used, (ii) 18.1 mg of the solid catalyst component was changed to 13.1 mg thereof, (iii) the propylene polymerization time of 60 minutes was changed to 20 minutes, (iv) 1.8 MPa of hydrogen was added to the propylene polymerization, (v) the ethylene gas-flow rate of 3.0 NL/minute was changed to 1.1 NL/minute, (vi) the propylene gas-flow rate of 5.5 NL/minute was changed to 6.0 NL/minute, (vii) hydrogen gas having a flow rate of 0.03 NL/minute was used, (viii) the copolymerization temperature of 55° C. was changed to 60° C., and (iX) the copolymerization time of 120 minutes was changed to 60 minutes, thereby obtaining 301 g of a copolymer of propylene and ethylene (herein referred to as “olefin polymer (4)”).

Olefin polymer (4) was found to have [η]T of 1.02 dl/g; the propylene homopolymer in olefin polymer (4) was found to have [η]P of 0.91 dl/g; and the propylene-ethylene random copolymer in olefin polymer (4) was found to have [η]EP of 1.35 dl/g. Olefin polymer (4) was found to contain 24.8% by weight of the propylene-ethylene random copolymer. The propylene-ethylene random copolymer was found to contain 18.2% by weight of a polymerization unit of ethylene. Results are shown in Table 1.

### Example 3

There were melt kneaded under the following conditions 5 parts by weight of olefin polymer (1), 95 parts by weight of olefin polymer (3) (as the propylene polymer), and 0.25 part by weight of additives (0.05 part by weight of calcium stearate, 0.1 part by weight of IRGANOX 1010, and 0.1 part by weight of IRGAFOS 168), thereby obtaining a polypropylene resin composition:
extruder: co-rotating twin screw extruder, KZW 15 TW-45 MG, manufactured by Technovel Corporation,
screw diameter: 15 mm,
screw L/D: 45
screw rotation speed: 500 rpm,
extrusion capacity: 3 kg/hours, and
preset temperature: 190° C. (zone C1), 200° C. (zone C2), 200° C. (zone C3), 200° C. (zone C4), 200° C. (zone C5), 200° C. (zone C6), and 200° C. (die).

The polypropylene resin composition was molded under the following conditions, thereby obtaining test pieces for measuring properties mentioned hereinafter:
molding machine: injection machine (TOYO SI-30III),
mold temperature: 50° C.,
barrel temperature (from upstream side): 190° C., 210° C., 220° C. and 220° C.,
back pressure: 5 MPa, and
injection speed: 20 mm/second.

The polypropylene resin composition was found to have a melt flow rate (MFR) of 42 g/10 minutes, flexural modulus of 1,160 MPa, Izod impact strength of 8.1 KJ/m², and gloss of 62%. Results are shown in Table 2.

The above melt flow rate (MFR) was measured according to ASTM D1238 under the following conditions:
preset temperature: 230° C., and
load: 21.1 N.

The above flexural modulus was measured according to ASTM D790 under the following conditions:
preset temperature: 23° C.,
thickness of test piece: 4 mm,
span: 64 mm,
loading speed: 2 mm/minutes, and
the number of test piece: 5

The above Izod impact strength was measured according to ASTM D256 under the following conditions:
measurement temperature: 23° C., and
thickness of test piece: 4 mm (V-notched).

The above gloss was measured according to ASTM D523 under the following conditions:
incidence angle: 60°, and
test piece: injection-molded 4 mm-thick flat plate.

### Example 4

Example 3 was repeated except that (i) 5 parts by weight of olefin polymer (1) was changed to 11 parts by weight of olefin polymer (2), and (ii) 95 parts by weight of olefin polymer (3) was changed to 89 parts by weight thereof, thereby obtaining a polypropylene resin composition.

The polypropylene resin composition was found to have MFR of 52 g/10 minutes, flexural modulus of 1,200 MPa, Izod impact strength of 7.0 KJ/m², and gloss of 65%. Results are shown in Table 2.

### Comparative Example 3

Example 3 was repeated except that (i) olefin polymer (1) was not used, and (ii) 95 parts by weight of olefin polymer (3) was changed to 100 parts by weight thereof, thereby obtaining a polypropylene resin composition.

The polypropylene resin composition was found to have MFR of 48 g/10 minutes, flexural modulus of 1,200 MPa, Izod impact strength of 6.5 KJ/m², and gloss of 52%. Results are shown in Table 2.

### Comparative Example 4

Example 3 was repeated except that (i) olefin polymer (1) was not used, (ii) 95 parts by weight of olefin polymer (3) was changed to 97 parts by weight thereof, and (iii) 3 parts by weight of an ethylene-octene copolymer rubber (EOR), ENGAGE 8842 manufactured by The Dow Chemical, was used, thereby obtaining a polypropylene resin composition.

The polypropylene resin composition was found to have MFR of 45 g/10 minutes, flexural modulus of 1,160 MPa, Izod impact strength of 7.7 KJ/m², and gloss of 53%. Results are shown in Table 2.

### Comparative Example 5

Example 3 was repeated except that (i) olefin polymer (1) was not used, (ii) 95 parts by weight of olefin polymer (3) was changed to 75 parts by weight thereof, and (iii) 25 parts by weight of olefin polymer (4) was used, thereby obtaining a polypropylene resin composition.

The polypropylene resin composition was found to have MFR of 57 g/10 minutes, flexural modulus of 1,130 MPa, Izod impact strength of 5.9 KJ/m², and gloss of 68%. Results are shown in Table 2.

Table 2 shows the following:
in comparison with Comparative Example 3, Examples 3 and 4 are excellent in their balance between flexural modulus and Izod impact strength, and are also excellent in their gloss;
in comparison with Comparative Example 4, Examples 3 and 4 are comparable to Comparative Example 4 in their balance between flexural modulus and Izod impact strength, however are better than Comparative Example 4 in their gloss; and
in comparison with Comparative Example 5, Examples 3 and 4 are comparable to Comparative Example 5 in their gloss, however are better than Comparative Example 5 in their balance between flexural modulus and Izod impact strength.

TABLE 1

| | | | Comparative | |
|---|---|---|---|---|
| | Example | | Example | |
| | 1 | 2 | 1 | 2 |
| Zinc atom-containing compound | 0.80 | 0.80 | 0 | 0 |
| (mmol-Zn used) | | | | |
| Solid catalyst component | 18.1 | 16.8 | 16.8 | 13.1 |
| (mg used) | | | | |
| Former polymerization | | | | |
| Hydrogen (MPa) | 0 | 1.2 | 1.8 | 1.8 |
| Time (minute) | 60 | 60 | 20 | 20 |
| Latter polymerization | | | | |
| Ethylene (NL/minute) | 3.0 | 3.0 | 6.0 | 1.1 |
| Propylene (NL/minute) | 5.5 | 5.0 | 5.0 | 6.0 |
| Hydrogen (NL/minute) | 0 | 0 | 0.1 | 0.03 |
| Temperature (° C.) | 55 | 55 | 60 | 60 |
| Time (minute) | 120 | 150 | 30 | 60 |
| [η]T (dl/g) | 2.53 | 1.17 | 1.24 | 1.02 |
| [η]P (dl/g) | 3.02 | 0.79 | 0.93 | 0.91 |
| [η]EP (dl/g) | 2.24 | 2.18 | 2.71 | 1.35 |
| Random copolymer content | 63.1 | 27.3 | 17.4 | 24.8 |
| (% by weight) | | | | |
| Ethylene unit content | 41.1 | 42.0 | 51.6 | 18.2 |
| (% by weight) | | | | |

TABLE 2

| | | | Comparative | | |
|---|---|---|---|---|---|
| | Example | | Example | | |
| | 3 | 4 | 3 | 4 | 5 |
| Polymer (part by weight | | | | | |
| used) | | | | | |
| Olefin polymer (1) | 5 | | | | |
| Olefin polymer (2) | | 11 | | | |
| Olefin polymer (3) | 95 | 89 | 100 | 97 | 75 |
| Olefin polymer (4) | | | | | 25 |
| EOR | | | | 3 | |
| Property of resin | | | | | |
| composition | | | | | |
| MFR (g/10 minutes) | 42 | 52 | 48 | 45 | 57 |
| Flexural modulus (MPa) | 1,160 | 1,200 | 1,200 | 1,160 | 1,130 |
| Izod impact strength | 8.1 | 7.0 | 6.5 | 7.7 | 5.9 |
| (KJ/m²) | | | | | |
| Gloss (%) | 62 | 65 | 52 | 53 | 68 |

1. A process for producing an olefin polymerization catalyst, comprising steps of:
(1) contacting 1 part by mol of a zinc compound represented by following formula [1] with more than 0 part by mol to less than 2 parts by mol of a halogenated alcohol represented by following formula [2], thereby forming a zinc atom-containing compound; and
(2) contacting the zinc atom-containing compound, a solid catalyst component containing a titanium atom, a magnesium atom and a halogen atom, an organoaluminum compound, and an external electron donor with one another:
Zn(L¹)₂ [1]
wherein L¹ is a hydrocarbyl group having 1 to 20 carbon atoms, and two L¹s are the same as, or different from each other; and 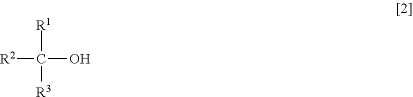
wherein R¹, R² and R³ are a hydrogen atom or a perhalocarbyl group having 1 to 20 carbon atoms, and are the same as, or different from one another; one or more of R¹, R² and R³ are the perhalocarbyl group; and any two or three of R¹, R² and R³ may be linked to one another to form a ring.

2. The process according to claim 1, wherein the zinc atom-containing compound is a compound represented by following formula [3] and/or its associate: 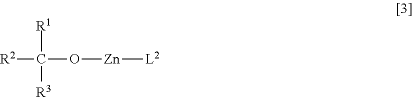
wherein R¹, R² and R³ are the same as those in formula [2], respectively; and L² is a hydrocarbyl group having 1 to 20 carbon atoms.

3. A process for producing an olefin polymer, comprising a step of polymerizing an olefin in the presence of an olefin polymerization catalyst produced by the process of claim 1.

4. A polypropylene resin composition comprising 1 to 50% by weight of an olefin polymer produced by the process of claim 3, and 50 to 99% by weight of a propylene polymer, provided that the total of the olefin polymer and the propylene polymer is 100% by weight.
